(19) United States
(12) Patent Application Publication
(10) Pub. No.: US 2019/0160415 A1
(43) Pub. Date: May 30, 2019

(54) APPARATUS AND METHOD FOR SEPARATING OIL PARTICLES FROM AN AIR STREAM

(71) Applicant: Step-Tec AG, Luterbach (CH)

(72) Inventors: Edwin Reinhard, Niederoenz (CH); Gianni Fazzone, Fulenbach (CH)

(21) Appl. No.: 16/192,819

(22) Filed: Nov. 16, 2018

(30) Foreign Application Priority Data
Nov. 30, 2017 (EP) 17 204 572.6

(51) Int. Cl. B01D 46/52; B01D 46/24; B01D 46/00; B01D 39/20

(52) U.S. Cl. CPC B01D 46/522; B01D 46/2411; B01D 2239/1291; B01D 39/2024; B01D 2239/1258; B01D 46/0031

(57) ABSTRACT

A filter for separating oil particles from an air stream includes a continuous side wall in which a filter material is accommodated, a completely uninterrupted floor, and a cover. The side wall is fastened between the floor and the cover and the filter material includes a fibre mixture of synthetic fibres and glass fibres. The filter material is configured such that, upon the inflow of the air stream through the filter material, the oil particles from the air stream agglomerate into drops on the surface of the material and the drops run off downwards.

### CROSS REFERENCE TO RELATED APPLICATIONS

This application claims benefit to European Patent Application No. EP 17 204 572.6, filed Nov. 30, 2017, which is incorporated by reference herein.

### FIELD

The invention relates to an apparatus and a method for separating oil particles from an air stream. In particular, the invention relates to a filter element and the use thereof for separating oil particles from an air stream, for example an air stream evacuated from a spindle chamber of a machine tool.

### BACKGROUND

High-performance spindles of machine tools are lubricated and cooled by an oil-air mixture. With the deaeration of the spindle interior, it is ensured that the oil mist created by the spindle operation is evacuated. The secondary contamination is in this way carried away and prevents deposits in the spindle interior. With the discharge of the oil mist, moreover, heat escapes, and so an overheating of the system is prevented.

Known methods and apparatuses for separating oil particles from the air stream evacuated from the spindle interior do not meet expectations, because either a very weak separation rate is achieved or the filter media become contaminated within a very short time. This results in an excessively high counterpressure, causing a back draught in the air stream, which in turn leads to an unsatisfactory deaeration of the spindle. An over-lubrication, elevated temperatures and excessive wear are the consequences.

In the event of a weak separation rate, particles can make their way into the ambient air, which can inflict considerable damage on man, the environment and the machine.

At issue here are so-called E-dust/mist (respirable <4 μm) and A-dust/mist (alveolar <1 μm). In the use of high-performance cooling lubricants, which are nowadays equipped, inter alia, with additives such as, for instance, droplet reducers, sub-micron particles are typically generated. High-frequency spindles, high-pressure systems, multi-shift operation and high temperatures promote the incidence of this critical particle size still further. Critical particles are diffusing particles. They are capable of penetrating even dense filter mats. This has the consequence that, although a separator can have a very acceptable residual emission value, the fraction which it does not capture contains precisely the type of particles which have been described above.

DE 20 2013 100421 describes an oil mist separator for cleaning oil mist out of the air of a work area. The separator has an at least two-stage filter, which is successively flowed through in a flow channel. The suction is realized by means of a fan in the air path behind the last filter, wherein the first filter in the flow channel is designed as the main filter and the filter arranged downstream of this in the air path is designed as the after-filter.

DE 10 2014 224 831 describes an oil filter arrangement of an oil separator having a housing. The housing has an air inlet and an air outlet, in which a multiplicity of filter elements is found. The filter elements contain a material which lies above steel in the triboelectric series.

### SUMMARY

In an embodiment, the present invention provides a filter for separating oil particles from an air stream. The filter includes a continuous side wall in which a filter material is accommodated, a completely uninterrupted floor, and a cover. The side wall is fastened between the floor and the cover and the filter material includes a fibre mixture of synthetic fibres and glass fibres. The filter material is configured such that, upon the inflow of the air stream through the filter material, the oil particles from the air stream agglomerate into drops on the surface of the material and the drops run off downwards.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a perspective exploded view of an apparatus for separating oil particles from an air stream according to an embodiment of the invention;

FIG. 2 shows a perspective exploded view of a filter element according to an embodiment of the invention;

FIG. 3 shows a perspective side view of the filter element of FIG. 2;

FIG. 4 shows a perspective top view of the filter element of FIG. 2; and

FIG. 5 shows a measured pressure pattern with the separator according to FIG. 1.

### DETAILED DESCRIPTION

Embodiments of the invention provide improved apparatuses and methods for separating oil particles from an air stream. Embodiments of the invention provide filter elements and apparatuses for separating oil particles from an air stream, which filter elements offer a compact design and an improved filtration and have an increased service life. Embodiments of the invention further provide methods for separating oil particles from an air stream and apparatuses for performing such methods, in which methods even very fine particles are separated from the air stream and afterwards drain out of a filter material to reduce or eliminate back pressure and ensure a sustained deaeration of the system.

Using the described filter material and considering the defined inflow velocity, an efficient filtration and a passive regeneration of the filter material is successfully achieved. Passive regeneration means that the filter medium can clean itself without outside influence, such as, for example, counterflow purge air, vibratory dedusting or brush cleaning. As a result, a compact and energy-efficient apparatus for separating oil particles from the air stream can be realized.

In one or more embodiments, a filter element for separating oil particles from the air stream comprises a continuous side wall, a completely uninterrupted floor and a cover. The side wall is fastened between the floor and the cover. In the side wall is accommodated a filter material, which consists of a fibre mixture of synthetic fibres and glass fibres. Moreover, the filter material is selected such that, upon the inflow of the air stream through the filter material, the oil particles from the air stream agglomerate into drops on the surface of the filter material and the drops run off downwards. The particles having a diameter in the in the micrometre range are hence retained from the air stream. The separation process works passively without external energy and the pressure loss across the filter element remains stable over a long period. Since the oil particles agglomerate and can subsequently be drained, a saturation of the filter material by oil particles in a short operating time is avoided, and hence a longer service life and better filtration of the filter element achieved. Furthermore, the passive filter function contributes to a low energy consumption of the apparatus.

According to one or more embodiments, the side wall has a supporting element for supporting the filter material, which supporting element is preferably formed of an internal rib mesh and/or an external rib mesh. The internal rib mesh and the external rib mesh preferably consist of expanded metal or perforated sheet metal. It is possible for the supporting element to be formed from other materials and shapes.

According to one or more embodiments, the filter material possesses a weight per unit area of 50-150 g/m², preferably of 90-150 g/m². In an advantageous variant, a filter material having a weight per unit area of 84 g/m² is chosen.

According to one or more embodiments, the filter material possesses a thickness within the range 0.1-1 mm, preferably within the range 0.1-0.69 mm.

According to one or more embodiments, the filter material possesses an air permeability of 80-250 m³/m²/h at 200 pa, preferably of 120-150 m³/m²/h at 200 pa. In an advantageous variant, the filter material is chosen with an air permeability of 130 m³/m²/h at 200 pa.

According to one or more embodiments, the filter material has a surface resistance of at least 10¹² Ohm. That has the advantage that, as a result of the air friction, unnecessarily static loads are not generated within the filter medium. The load promotes the adherence of suspended particles and can alter the surface tension of liquids, so that a run-off can be made more difficult.

According to one or more embodiments, the filter element has the form of a hollow cylinder. The filter element can assume a different shape, for example conical. A conical element, in particular when it is suspendingly mounted, promotes the run-off of a drop.

According to one or more embodiments, the filter material has a multiplicity of folds for the enlargement of the filter area. In a preferred variant, the folds run in a vertical direction in order to promote the agglomeration of the oil particles into drops and the run-off of the drops.

According to one or more embodiments, the depth of the folds in the radial direction equals 10-30 mm. In a preferred variant, a depth of 25 mm is chosen. In a variant, the fold spacing is chosen in dependence on the inner diameter of the filter material and the thickness of the material.

In one or more embodiments, the filter material is designed with reinforcing elements in order to attain more mechanical stability of the filter material.

In one or more embodiments, the filter element is dimensioned such that the ratio between the height of the filter element and the external diameter of the side wall of the filter element is 1 or greater in order to obtain an optimum between the mechanical stability of the filter element and the efficiency of the filtration.

In one embodiment or more embodiments, an apparatus for separating oil particles from the air stream comprises a filter element, a housing, an inlet for the laden air stream, an outlet for the separated air stream and a drain for oil. An inflow velocity of the air stream is dimensioned such that, upon the inflow of the air stream through the filter material, the oil particles from the air stream agglomerate into drops and the drops run off downwards. The inflow velocity is a relevant factor for enabling the agglomeration of the oil particles.

According to one or more embodiments, an apparatus is provided that includes a diffuser disposed between the side wall of the housing and the filter element. As a result, the air stream is guided via the diffuser as evenly as possible into the expansion chamber, in which also the filter element is found, and the inflow velocity is readjusted. This results in an optimal ratio between filter area and inflow velocity.

According to one or more embodiments, the inflow velocity lies within the range 0.1-2.5 m/min, preferably within the range 0.1-0.55 m/min. The inflow velocity outside this range has an adverse effect on the efficiency of the filtration by preventing the agglomeration of the oil particles. Since the aerosols can penetrate too deeply into filter medium, the drainage becomes less efficient and the differential pressure across the filter element increases.

One embodiments comprise an application of a filter element in an apparatus for separating oil particles from the air stream. The apparatus comprises a filter element, a housing, an inlet for the laden air stream, an outlet for the separated air stream, and a drain for oil. An inflow velocity of the air stream is dimensioned such that, upon the inflow of the air stream through the filter material, the oil particles from the air stream agglomerate into drops and the drops run off downwards. The inflow velocity is a relevant factor for enabling the agglomeration of the oil particles.

According to one or more embodiments, a method is provided for separating oil particles from an air stream, wherein the laden air stream is conducted into an expansion chamber, in which a pleated, vertically arranged filter material consisting of a fibre mixture of synthetic fibres and glass fibres is found. The filter material and the inflow velocity of the air stream are chosen such that, upon an inflow of the air stream through the filter material, the oil particles from the air stream agglomerate into drops on the surface of the filter material and the drops run off downwards.

According to one or more embodiments, methods are provided in which a filter material having a thickness within a range 0.1-1 mm, a weight per unit area of 50-150 g/m², an air permeability of 80-250 m³/m²/h at 200 Pa, and a surface resistance of at least 10¹² Ohm is utilized. The laden air stream is conducted through the filter material at an inflow velocity within the range 0.1-2.5 m/min. In one or more variants, the filter material has a bursting strength (according to Mullen) of 300 kPa. In one or more embodiments, the filter material has a temperature resistance of 65° C. to 80° C.

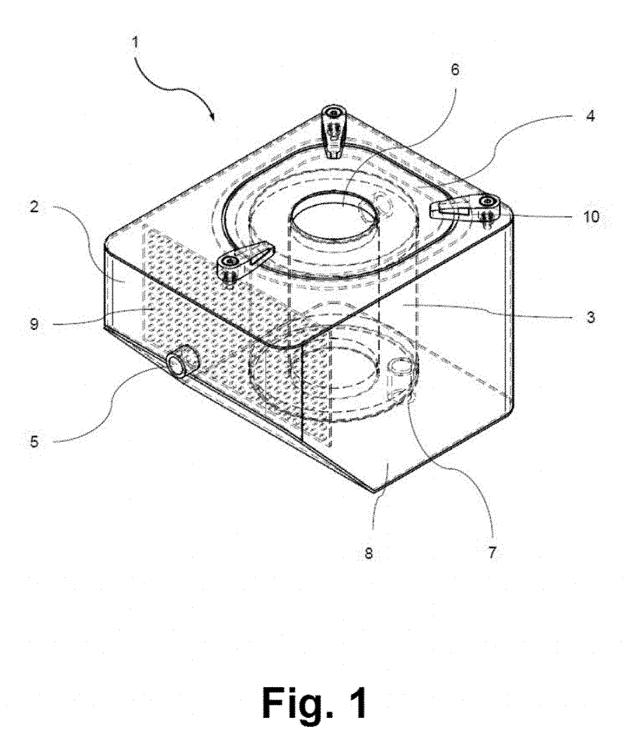

FIG. 1 shows in a perspective exploded view an apparatus 1 for separating oil particles from an air stream. The apparatus has a housing 2 having an opening on the top side in order that a filter element 3 can be arranged exchangeably through the opening in the housing. On the top side of the housing and next to the opening, a plurality of closure elements 10 are provided in order to hold the filter element in the housing. The closure elements allow the filter element to be held stably in the housing during operation and to be easily installed.

On one side wall of the housing 2 is disposed an inlet 5 for contaminated air. On the cover of the filter element is provided an outlet 6, through which the cleaned air stream leaves the housing 2. In the floor 8 of the housing 2 is provided a drain 7 for the separated oil, which drain is periodically opened by a valve (not represented) in order to let the collected oil flow out. Close to the inlet 5 is optionally disposed a perforated metal sheet 9 as a diffuser for the distribution of the incoming contaminating air in the housing.

FIG. 2 shows the filter element 3, which has the form of a hollow cylinder. In the side wall is accommodated a filter material 32, which is fixed vertically in the floor 35 of the filter element. The filter material 32 is supported on the inside and on the outside by a rib mesh 33, 34, which rib meshes consist, for instance, of braided wire, expanded metal or perforated sheet metal.

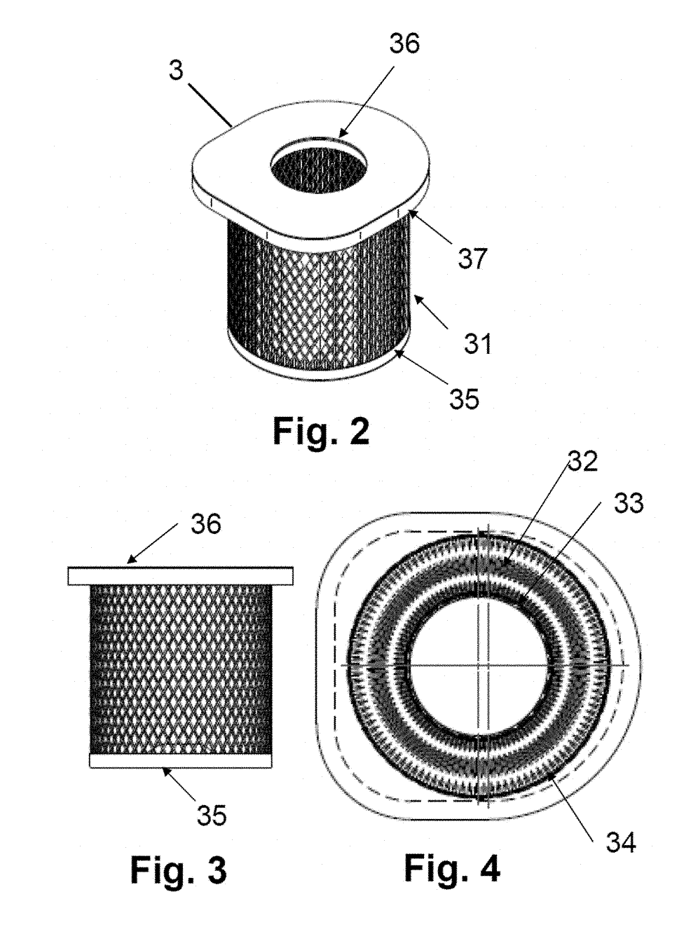

FIG. 4 shows a top view of the arrangement of the filter material 32, internal rib mesh 33 and external rib mesh 34. Through the support of the internal rib mesh 33 and external rib mesh 34, the elastic deformation of the filter material by the inflow of the air stream is massively reduced or even avoided.

Advantageously, the filter element 3 has at the bottom a completely uninterrupted floor. The choice of material for the floor is dependent on the application. For the embodiment represented in FIG. 2, the floor is made of electrogalvanized steel.

The filter element further has a cover 36, which is fixedly connected to the filter material and the rib mesh and on which the outlet 6 for the cleaned air stream is disposed. As shown in FIG. 2, the cover can have a specific shape in order to facilitate the installation of the filter element in the housing 2. On the bottom side of the cover is provided a seal 37, which serves as a seal between the filter element and the housing.

A pleated filter material is used to obtain an optimal filtration. Pleated means that the sheet-like filter material 32 is folded in a zigzag shape. The filter material represented in FIGS. 2, 3 and 4 has a plurality of folds. The filter material consists of a fibre mixture of synthetic fibres and glass fibres. In a preferred variant, the filter material has a thickness of 0.69 mm, a weight per unit area of 84 g/m², and an air permeability of 130 m³/m²/h at a pressure of 200 Pa, and a surface resistance of at least 10¹² Ohm.

A preferred embodiment of the apparatus 1 is operated such that the laden air stream flows at an inflow velocity of 0.55 m/min from outside to in through the filter material 32. Advantageously, the filter material 32 additionally has a bursting strength (according to Mullen) of 300 kPa and a temperature resistance of 65° C. to 80° C.

The embodiment represented in FIGS. 2, 3, and 4 is dimensioned such that the height of the filter element measures 150 mm and the external diameter of the side wall is 138 mm.

FIG. 3 and FIG. 4 show respectively a perspective side view and top view of the filter element.

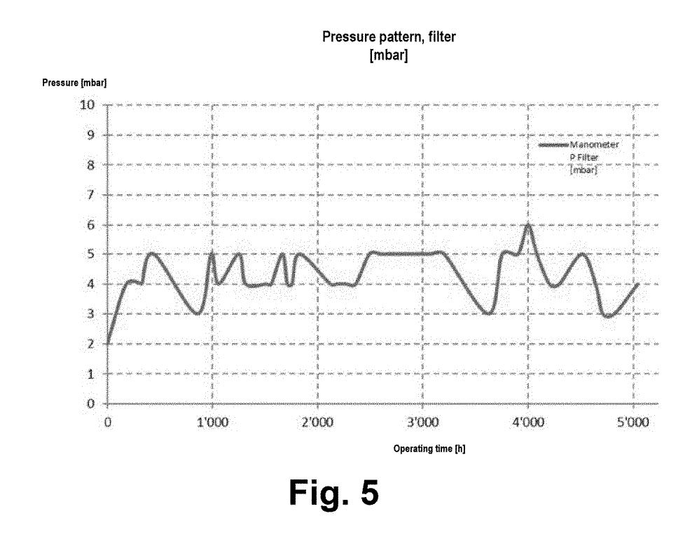

FIG. 5 shows a measurement of the pressure pattern of the apparatus as a function of the operating time. With the previously described apparatus 1 and operating method, measurements were conducted on a MIKRON HPM 450U machine tool at a spindle speed of 20,000 min⁻¹. The three bearings were lubricated by means of MOTOREX SPINDLE LUBE ISO VG 68 HYPER 15/13/10, wherein the supplied quantity amounted to 0.00091/h. This resulted in a concentration, depending on the evacuated volume flow, of 0.0631 to 0.1091 ml/m³. This corresponds to an average load of 99,570 mg/m³, with which the oil-mist-contaminated waste air which was generated by the passive pressurized system in connection with the bearing lubrication was supplied to the apparatus 1 for a total over 5,000 hours. The apparatus 1 here acted as a deaeration member and possessed no fan of its own for equalizing the pressure differential across the filter element 3. In the waste air stream after the apparatus 1, only 0.195 mg/m³ were measured, corresponding to a reduction of 500:1. FIG. 5 shows a graph in which the ordinate shows the pressure differential across the filter element in mbar and the abscissa the operating period in hours. It can clearly be seen that the pressure differential never exceeded the value of 6 mbar.

The separation process thus functioned passively for over 5,000 hours, thus without introduction of an external energy such as compressed air, electric current, etc., wherein the pressure loss across the filter element remained stable, below 6 mbar. It has been shown during operation that the oil mist in the filter material agglomerated into drops, which ran off downwards without clogging the filter material in the measurement period, so that it is possible to speak of a self-regenerating process.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

LIST OF REFERENCE NUMERALS

```
  1 apparatus for separating oil particles
  2 housing
  3 filter element
  4 cover
  5 inlet for laden air
  6 outlet for clean air
  7 drain for oil
  8 floor of the filter element
  9 diffuser
10 closure element
31 side wall
32 filter material
33 internal rib mesh
34 external rib mesh
35 floor of the housing
36 cover
37 seal
```

What is claimed is:

1. A filter for separating oil particles from an air stream, the filter comprising:
a continuous side wall in which a filter material is accommodated;
a completely uninterrupted floor; and
a cover,
wherein the side wall is fastened between the floor and the cover,
wherein the filter material includes a fibre mixture of synthetic fibres and glass fibres,
wherein the filter material is configured such that, upon the inflow of the air stream through the filter material, the oil particles from the air stream agglomerate into drops on the surface of the material and the drops run off downwards.

2. The filter according to claim 1, wherein the side wall has an internal rib mesh and/or an external rib mesh configured to support the filter material, wherein the internal rib mesh and/or the external rib mesh include expanded metal or perforated sheet metal.

3. The filter according to claim 1, wherein a weight per unit area of the filter material is 50-150 g/m².

4. The filter according to claim 1, wherein a thickness of the filter material is within a range of from 0.1 mm-1 mm.

5. The filter according to one of claim 1, wherein the filter material possesses an air permeability of 80-250 m³/m²/h at 200 pa.

6. The filter according to claim 1, wherein the filter material possesses a surface resistance of at least 10¹² Ohm.

7. The filter according to claim 1, wherein the filter element has the form of a hollow cylinder.

8. The filter according to claim 1, wherein the filter material is equipped with a multiplicity of folds.

9. The filter according to claim 1, wherein the depth of the folds in the radial direction is between 10-30 mm.

10. An apparatus for separating oil particles from a laden air stream, the apparatus comprising:
a filter;
a housing;
an inlet for the laden air stream;
an outlet for a separated air stream; and
a drain for oil,
wherein the filter is disposed in the housing,
wherein the apparatus is configured such that, upon the inflow of the laden air stream through the filter, the oil particles from the laden air stream agglomerate into drops on a surface of a filter material, and
wherein the drops run off downwards.

11. The apparatus according to claim 10, wherein a diffuser is disposed between a housing side wall and the filter.

12. The apparatus according to claim 10, wherein an inflow velocity of the laden air stream lies within a range 0.1-2.5 m/min.

13. A method for separating oil particles from an air stream, the method comprising:
conducting the air stream into an expansion chamber, in which a vertically arranged filter material consisting of a fibre mixture of synthetic fibres and glass fibres is disposed, and
selecting the filter material and an inflow velocity of the air stream through the filter material such that, upon inflow of the air stream through the filter material, the oil particles from the air stream agglomerate into drops on a surface of the filter material and such that the drops run off downwards.

14. The method according to claim 13, wherein the filter material has a weight per unit area of 50-150 g/m², a thickness of 0.1 mm-1 mm, an air permeability of 80-250 m³/m²/h at 200 Pa, and a surface resistance of at least 10¹² Ohm, and wherein the inflow velocity of the air stream is within the range 0.1-2.5 m/min.

15. The method according to claim 13, wherein the filter material has a bursting strength (according to Mullen) of 300 kPa.
